(19) United States
(12) Patent Application Publication
(10) Pub. No.: US 2024/0129145 A1
(43) Pub. Date: Apr. 18, 2024

(54) METHOD AND CIRCUIT FOR OPERATING A NETWORK OR NETWORK SECTION

(71) Applicant: Turck Holding GmbH, Halver (DE)

(72) Inventor: Johannes vom Stein, Hückeswagen (DE)

(21) Appl. No.: 18/480,548

(22) Filed: Oct. 4, 2023

(30) Foreign Application Priority Data
Oct. 14, 2022 (DE) 10 2022 126 893.4

(51) Int. Cl. H04L 12/10; H04L 12/40

(52) U.S. Cl. CPC H04L 12/10; H04L 12/40045

(57) ABSTRACT

A Powered Device (PD) for connecting to a Power Sourcing Equipment (PSE) via a network line of a network contains, as electronic components, a coupler for connecting to the PSE and for separating supply and communication, at least one logic unit, and two input channels, wherein the coupler has two PSE ports and at least four PD ports, of which two PD ports are power ports and two PD ports are communication ports. The electronic components are supplied directly or indirectly via the two power ports and supply lines. In the supply line from the coupler to the at least one input channel a switching unit is arranged, and a supply branch extends from the switching unit to the logic unit, wherein the logic unit communicates with the coupler and further contains a supply storage or is connected thereto. Further, the disclosure comprises a method for operating such a PD.

### CROSS REFERENCE TO RELATED APPLICATIONS

This application claims priority to German patent application DE 10 2022 126 893.4 filed on Oct. 14, 2022, which is hereby incorporated by reference in its entirety.

### TECHNICAL FIELD

The present disclosure relates to a powered device (PD) for connecting a power sourcing equipment (PSE) via a network line of a network and an associated method for operating such a PD.

### BACKGROUND

With SPE (Single Pair Ethernet) or APL (Advanced Physical Layer), it is in principle possible to transmit a functionally safe protocol (e.g., PROFIsafe, CIPP Safety). The transmission path is used as a “black channel,” with secure packets being sent over an insecure path.

US 2017/0302508 A1 discloses an operating method of a first communication node in a vehicle network. It includes: Measuring a strength of a current supplied to a second communication node through a data line in the vehicle network, comparing the measured strength of the current to a predetermined threshold, generating an address resolution protocol (ARP) frame including error-related information if it is determined, based on a result of the comparison, that the second communication node is in an error state, and transmitting the ARP frame.

Further, it is known from US 2011/0047407 A1 to provide redundancy of data and/or inline power in a wired data telecommunication network from a first network device and a second network device. They are configured as power sourcing equipment (PSE) devices and are coupled to each other as well as coupled to a third network device (e.g., a PD) using a Y-connector. A redundant signaling to/from each pair of network devices is provided by coupling one port of each of the network devices to the Y-connector and from there to a third port at which a third network device, such as a PD, can be coupled. Given that the Y-device is substantially passive, communication paths are provided between the PSE devices and the PD to enable a master-slave status and the exchange of related information between the respective network devices.

The main disadvantage of these solutions is that either the status data of the PD are only sent intermittently or the logic processing must also be carried out with a high level of security. This requires complex structures, such as redundant microprocessors. The secure transmission of a digital information therefore requires a great effort in relation to hardware and software, in particular if the secure status has to be reported from the PD to the PSE.

### SUMMARY

It is an object of the present disclosure to provide a PD and an associated method for operating a PD connected to a PSE in a network having increased security (security level) in order to make reliable statements about the data integrity and a secure safety state.

This object is solved according to the disclosure by a PD having at least a coupler, one logic unit, two input channels, and a switching unit and an associated method for operating such a PD. Exemplary embodiments are disclosed in detail below.

Therefore, this object is accomplished by a PD for connecting to a PSE via a network line of a network. The PD has the following electronic components:
a coupler for connecting to the PSE and for separating supply and communication received via the network line, and
at least one logic unit and at least two input channels, wherein the coupler has two PSE ports and at least four PD ports, of which at least two PD ports are power ports and at least two PD ports are communication ports and wherein the electronic components are supplied directly or indirectly via the two power ports and the supply line. In the supply line from the coupler to the at least one input channel a switching unit is arranged, and a supply branch extends from the switching unit to the logic unit, wherein the logic unit comprises a supply storage and/or is connected thereto.

The PD according to the present disclosure is not restricted and can be, for example, an IO module, a combined device with output and input, a contactor with a feedback contact, a motor with a limit switch, a valve with position feedback, a door lock with feedback, etc.

The coupler is configured in such a way that it enables the electrical supply and the digital communication through passive components by separating them incoming from the PSE and routing the power ports and the communication ports of the PD to the respective connected line. In the opposite direction, the supply and the communication are merged and routed to the PSE. For this purpose, the coupler advantageously has a high-pass filter for the communication or the communication signal, respectively, and a low-pass filter for the supply. For example, in an exemplary embodiment, the coupler may be designed according to the IEEE 802.3cg:2019 standard.

The network and the associated network line is typically an SPE with PoDL (Power over Data Line) and designed according to one of the IEEE 802.3 standards or a comparable or derived standard, such as one of the IEC 61156 standards.

In the present disclosure, “supply” should always be understood as the power and/or voltage supply, unless something different is described. In contrast, “communication” should be understood to mean any form of data transmission (sending and receiving). Communication should in particular also include controlling and regulating of electronic components, in particular the controlling and regulating of electronic components by the logic unit. “Communication” is also understood to mean a digital signal that only conveys a state of an electrical or electronic component, as for example:
a current (flow) above or below a threshold, here, for example, a supply measuring unit on a switching unit or a logic unit,
a connected or not connected input (channel) or output (channel), or
an activated or deactivated load unit or load, for example, by a load unit, such as a resistor or a consumer, to the switching unit and/or a logic unit.

In the following, a “zero pulse” of the switching unit and/or a switch provided there should be understood as meaning that the switching unit disconnects the supply line, i.e., the switch does the switching so that the logic unit and, if necessary, also the supply input channel are separated from it.

The “load pulse” of the switching unit should be understood as meaning activating a load unit so that the output continues to be supplied and the safety state of the input is created by the pulse as a characteristic of the voltage and/or power consumption.

In the following, the switching of the switching unit is referred to as the “pulse” whereby both a zero pulse and a load pulse are covered by the term “pulse,” unless something specific is explicitly stated.

A safe input should be understood as meaning an input having at least two independent input channels which generate and transmit a redundant digital information about the state of the safe input by generating and transmitting digital information about the respective partial states of the at least two independent input channels. If one of the input channels fails due to an error, the error is detected by comparing the two input channels and transmitted.

A safe output consists of two output channels that represent two independent deactivation options. The deactivated state is considered a safety state. The state of the output is read back, in particular by the logic unit and/or the PSE. If there is a deactivation due to an error, for example, due to the failure of an electronic deactivation element, the output can be deactivated using a second deactivation option, such as a second electronic deactivation element.

In the present disclosure, the “first input channel” is also referred to synonymously as the “supply input channel” and the “second input channel” is also synonymously referred to as the “communication input channel.”

In an exemplary embodiment, the supply is completely provided via the supply line, from which electrical and electronic components are supplied directly or indirectly. Direct supply means that a component is connected to the supply line without an electronic component arranged in between and supplied via the supply line, wherein the direct supply can also take place via a line node. The indirect supply means any other supply, in particular the supply via a filtering, amplifying and/or attenuating electronic component and/or the supply via an electrical storage element.

In an exemplary embodiment, the supply is completely separated from the communication within the PD and takes place via separate lines or separate wires.

The logic unit is a single- or multi-part design and, in an exemplary embodiment, communicatively supplies a plurality of electronic components of the PD, in particular all electronic components of the PD. For this purpose, the logic unit comprises and/or uses one or more suitable software programs.

The logic unit typically comprises at least one microcontroller which is designed and/or uses suitable software to evaluate a communication protocol containing at least one information about a safety state which can in particular be transmitted redundantly on another channel. Therefore, the logic unit in particular reads an input, in particular a secure input channel. Further, the logic unit can control an output, in particular a secure output channel.

Advantageously, the logic unit may be connected via communication lines to several, in particular to all, components of the PD in order to detect their status and/or relevant operating and/or performance data in at least one diagnostic step. Therefore, the logic unit advantageously comprises additional, non-safety-relevant digital or analog inputs, outputs or other functional blocks.

In this way, in the PSE, the safe input state in the first safety channel, the supply safety channel, can be detected via the supply line and checked.

A high diversity of the two security channels is achieved by the fact that the security function of the supply security channel (supply) is not dependent on the hardware or software component in the logic unit of the communication security channel (communication).

A further improvement can be that the logic unit and/or the PSE are configured and/or include suitable software to recognize a characteristic supply by a supply unit or a supply storage in the supply branch.

Here, a characteristic supply should be understood as meaning an amount of current, a voltage and/or its temporal sequence (gradient) that cannot be generated randomly or with the highest statistical probability cannot be generated randomly, and in particular cannot be randomly provided by the supply line.

In this way, in addition to the supply security channel, the PSE can detect the supply of the logic element through the supply unit via the communication security channel, i.e., determine the switching state of the switching unit, which can be transmitted via the communication security channel. This safety state of the input can advantageously be transmitted from the logic unit to at least one communication port of the coupler and on to the PSE.

It may be an advantage that the switching unit comprises at least one time measuring unit and a switch, ideally a time measuring unit with two time measuring elements, wherein the switch controlled by the time measuring unit cyclically triggers pulses. The pulses can in particular be zero pulses, wherein the supply line is separated from the logic unit and, if necessary, additionally from the supply input channel. The time measuring elements by means of which the times are measured can be passive components such as resistors or capacitances and/or counter modules.

The switching unit is advantageously connected to at least one supply input channel such that the switching unit only triggers a load pulse when the supply input channel is active, in particular having a defined power consumption.

The switching unit advantageously comprises a field effect transistor (FET) or another transistor as a switch or is configured as such a component.

In an alternative exemplary embodiment, it may be provided that the switching unit is switched as required and/or a disconnection of the supply line, which is cyclically switched by the time measuring unit, is extended for a defined duration.

In an exemplary embodiment, at least one supply input channel is switchable via the switching unit by the supply line, i.e., the supply input channel can be separated from the supply line. Both input channels each detect a digital input signal, wherein the two input signals jointly form a safe input signal (safety state) because these two input signals (partial states) are detectable by the PSE as being redundantly or clearly inverted.

Advantageously, a safe input signal or the safety state, respectively, is defined by the two input signals from at least two input channels, in particular digital input signals which must have the same or an antivalent (partial) state in a defined time (dt). In this way, in the PD, the safe switching state (partial state) can be transmitted to the PSE in the first safety channel, the supply safety channel, whereby this occurs completely independently of the logic element.

Further, the safe partial state can be detected in the second safety channel, the communication safety channel, via the communication input channel and transmitted via the logic unit to the PSE.

A further exemplary embodiment may include the switching unit being configured to trigger one or more pulses and/or a characteristic pulse pattern for at least a period of time (dt), wherein the downstream assemblies are not supplied with power during the zero pulse. The supply input channel may advantageously be configured in such a way that zero pulses are used to detect cross-circuits of a potential-free contact, wherein the zero pulses may occur cyclically.

An advantageously present supply output channel can be configured in such a way that zero pulses are used to check the deactivation capability, wherein the zero pulses may also occur cyclically.

A “characteristic pulse pattern” means a temporal sequence of two or more pulses and at least one pulse pause, wherein the pulse pattern in particular is such that it cannot form randomly. This characteristic pulse pattern can be triggered in particular by the time measuring unit and is routed to the PSE via a communication port of the coupler.

A further exemplary embodiment may include a supply unit being arranged in the supply branch extending to the logic unit, the supply unit comprising at least one supply storage and a power adapter.

The power adapter advantageously comprises a direct current converter which converts the voltage provided by the supply storage to a defined, lower voltage. Therefore, the power adapter can include a constant-current sink used to set a constant power consumption.

In the supply branch from the switching unit to the logic unit, the supply storage can be arranged upstream or downstream of the power adapter.

A further exemplary embodiment may include the supply storage comprising at least one passive storage component and at least one passive directional component, wherein the storage component is, for example, a capacitance and/or an inductor and the at least one directional component is, for example, a diode.

The passive storage components can also be a group of storage components, ideally a group of passive storage components generating a characteristic supply or a characteristic increase or a deactivation of the supply during a pulse of the switching unit and compensating for the deactivation so that the logic unit is continuously, constantly supplied. As described above, it may be provided that a characteristic supply or a characteristic increase are detectable and evaluable by the logic unit.

Ideally, the logic unit cannot influence the pulses of the switching unit and is not itself influenced by them. In an exemplary embodiment, only the branch extending to the logic unit is switched by the switching unit, while a supply output and any supply output that may be present are not switched. The directional component serves to determine the current direction and in particular to prevent current flow in the direction to the supply input channel during a pulse.

A further exemplary embodiment may include the supply storage being configured and sized in such a way that the level (size) and/or the duration of the supply that can be provided does not enable operation of the output, wherein this refers to the unsafe operation of the output, i.e., a not-deactivated operation.

The supply, i.e., the required current strength and/or the required voltage, is typically less than 50% of the supply for an operation of the output, more typically less than 25%, even more typically less than 15%.

In a further exemplary embodiment the storage capacity of the supply storage is sized in such a way that the stored supply (amount of energy) is only sufficient for one pulse (pulse duration) and/or a characteristic pulse pattern of the switching element.

Further, it may be advantageous that the supply storage is configured in such a way that the recharging via the supply line and the parallel operation of the logic unit are possible.

A further exemplary embodiment may include a load unit being provided in the supply line between the coupler and the switching unit, wherein the load unit communicates with and/or is controlled by the switching unit.

In this way, during the pulse (zero pulse) in the supply line, i.e., during its separation, a defined load may be activated between the coupler and the switching unit, the activation of which being detectable and evaluable by the PSE (increased current flow or resistance). Ideally, the current or the voltage for the additional load unit is set to a defined value and/or a defined current and/or voltage pattern. In this way, the duration of the pulse of the switching unit for the PSE is positively detectable by way of the load pulse (increased current pulse), which represents a further security level.

The PSE advantageously evaluates the first partial state of the supply security channel (first security channel) by continuously measuring the current and acquiring cyclically occurring pulses below or above a defined threshold as a measure or digital information. The absence of cyclic pulses is also detected. The communication with the PD via a communication protocol provides the same information about the unsafe or secure partial state in the communication security channel. The redundantly transmitted information of the two partial states can be evaluated as to whether an overall safety state of the PD is given. If there is a discrepancy, the safety state can be generated.

Advantageously, in case of the load being activated, the unsafe or safe partial state can be executed as a load pulse via the load unit. The higher load current then does not have to be interrupted for, e.g., a supply input or output. When the load is deactivated, the unsafe or safe partial state can be executed as a zero pulse.

Ideally, the additional load unit is communicatively switched by the switching unit, an alternative being that a communication line from the logic unit to the load unit exists and the load unit is switched instead of the supply unit supplying the logic unit.

A further exemplary embodiment may include a supply measuring unit that communicates with the switching unit being provided in the supply line, wherein, depending on the supply value detected by the supply measuring unit, the switching unit can be configured to generate a zero pulse or a load pulse.

This exemplary embodiment has the advantage that the current and/or voltage changes are limited in magnitude, which means that switching can be carried out more quickly and accordingly there is less load on the components.

The supply measuring unit is ideally a current measurement device that detects the current value, for example, through a shunt resistor or via a magnetic Hall sensor. The supply measuring unit is connected to the switching unit and/or the logic unit via a communication line. Depending on the measured current in the supply line
a zero pulse or
a load pulse
   is triggered.

The disclosure also comprises a method for operating a PD connected to a PSE in a network, wherein the PD comprises the following:
a coupler via which it is connected to a PSE,
a supply line via which the electronic components are supplied,
a logic unit via which the PD communicates with the PSE,
at least two input channels.

The safety state is achieved by the following at least two security channels, the supply security channel and the communication security channel, each with their own partial states:
the first partial state of the supply safety channel is to transmit for a first input channel, during a zero pulse or a load pulse in the supply line, a value as digital information about the supply, in particular the current value or the current flow, in a supply line of the PD to the PSE, and, in parallel,
the second partial state of the communication security channel is to transmit the identity of the data, that is, whether a secure (partial) state exists or not, from at least one further input channel via the logic unit to the coupler, wherein
i) parallel to or by the zero pulse at least the logic unit is separated from the supply line and the logic unit is supplied via a supply storage of the PD for the duration of the separation (zero pulse), or
ii) parallel to the load pulse the voltage is converted upstream of the logic unit from a first higher voltage to a second lower voltage.

The logic unit is hereby integrated into a supply branch connected to the supply line via a switching unit.

Here, “parallel” means that an event occurs “simultaneously at the same time” or “almost simultaneously” so that, for example, the generation and communication of the further, secure partial state occurs simultaneously or almost simultaneously.

To avoid repetition and given the technical proximity, all advantages, aspects and designs regarding the PD, the PSE and/or the network should apply identically or in an analogous manner to the method and vice versa.

In an improved method, an increase in safety may include the supply line being separated by the PSE and the switching unit of the PD (zero pulse).

Advantageously, the zero pulse and/or the load pulse is triggered and/or controlled by at least one switching unit, wherein the switching unit is advantageously arranged in the supply line.

In a further exemplary embodiment of the method, an advantage may be charging the supply storage outside of a pulse or a pulse pattern via the supply line and separating it from the supply line via the switching unit.

Thus, the particular advantage is that the secure input (safety state) is transmitted via redundant, completely decoupled channels. This is a supply input channel (current) and a second communication input channel (data), both of which transmit the same or analog information, respectively, about a safe partial state of the input to the PSE and thus about an overall safety state.

In a further exemplary embodiment of the method, an advantage may be if additionally or alternatively a secure output is formed via redundant channels in an analogous manner. This is achieved in an analogous manner via a first supply output channel (current, first partial state) and a second communication output channel (data, second partial state). The two channels receive the same information about the activation or deactivation of the output from the PSE, i.e., the two partial states of the input channels.

In a further exemplary embodiment of the method, an advantage may be if in the second partial state of the communication security channel in parallel to the zero pulse according to alternative i) the voltage provided by the supply storage is converted from a first higher voltage to a second lower voltage upstream of the logic unit.

In an exemplary embodiment of the method, it may be provided that in parallel to the load pulse in the first partial state of the supply safety channel at least one of the following circuits is present:
the first input channel, also called the supply channel, is connected to the PSE and the supply line in a current-conducting manner, and/or
an output channel is connected to the PSE and supply line in a current-conducting manner.

In this way, a safety state of the PD can be transmitted in particular to a subsequent component via the output.

In a further exemplary embodiment of the method, an advantage may include the presence or absence of a safety state (first, second partial state) being triggered by means of the switching unit, clocked as a pulse, and being detected for the logic unit and/or the PSE. A pulse duration may advantageously be 1 ms to 50 ms and a period duration may be 300 ms to 800 ms.

In an exemplary embodiment, the period duration is 500 ms.

In a further exemplary embodiment of the method, one advantage may include the logic unit being only supplied via the supply storage for the duration of the separation from the supply line by the switching unit. An improvement here may be that the withdrawal from the supply storage to the logic unit takes place via a power adapter, in particular a DC converter, so that a constant current value or voltage is provided.

In a further exemplary embodiment of the method, an advantage may be that the supply and/or the direct current provided by the supply storage device is configured in such a way that no unsafe operation of the output is possible because this is rendered impossible by the required level (size) and/or the minimum (supply) duration.

For example, a configuration can be such that there is a power requirement of 30 mA for the operation of the logic unit and the input channels. On the other hand, the power requirement of the PSE ports (output) is, for example, 300 mA, i.e., 10-fold, so that they cannot be operated via the supply from the supply unit, even in the event of a malfunction or error.

Advantageously, the switching edges of the supply are carried out by the supply unit at a defined current value and are changed correspondingly sluggishly so that a low-pass filter arranged in the coupler and/or a corresponding filter of the PSE can be passed.

In an advantageous variant of the method, an advantage may be if the PD is configured for connection to a PSE via a network line of a network according to one of the variants and embodiments mentioned herein.

### BRIEF DESCRIPTION OF THE DRAWINGS

The disclosure will now be described with reference to the drawings wherein:

FIG. 1 shows a PD in the connection with a PSE as a network;

FIG. 2 shows a PD in an alternative connection as in FIG. 1;

FIG. 3 shows a PD in a further connection as in FIG. 1 or FIG. 2,

FIG. 4 shows a diagram of a first switching pulse sequence over time; and

FIG. 5 shows a diagram of a further switching pulse sequence over time.

### DESCRIPTION OF EXEMPLARY EMBODIMENTS

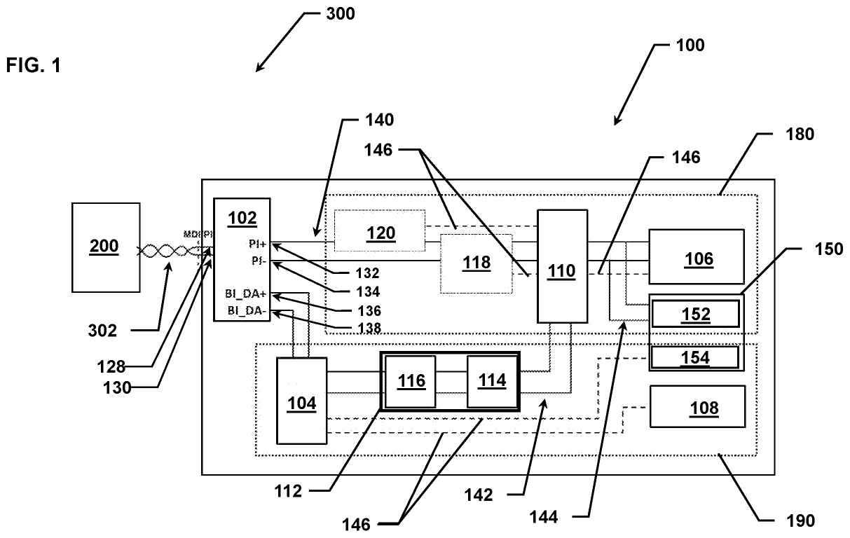

FIG. 1 shows a PD 100 which is connected to a PSE 200 in a network 300 via a network cable 302. The network 300 is an SPE with PoDL and the network line 302 is an associated two-wire cable that is standardized accordingly.

The PD 100 is shown in FIG. 1 only with the components for safe operation for the communication of safe status data and can include further functional components.

The PD 100 has a coupler 102 as a connecting element to the PSE 200 and for connecting to the network line 302, the coupler 102 having two PSE ports 128, 130 for connection to the network cable 302. Further, the coupler 102 has two power ports 132, 134 and two communication ports 136, 138.

The supply line 140 is connected via the power ports 132, 134, and communication with a logic unit 104 is established via the communication ports 136, 138.

Further, the PD 100 comprises, in addition to the logic unit 104, two input channels 106, 108 and a switching unit 110 arranged in the supply line 140 from the coupler 102 to the first supply input channel 106. Further, a supply branch 142 extends from the switching unit 110 to the logic unit 104, and in the supply branch 142 a supply unit 112 is connected in series to a supply storage 114 and a power adapter 116.

The PD 100 also comprises a second communication input channel 108, an output channel 150 with a supply output channel 152 and a communication output channel 154. The output channel 150 is connected to the supply line 140 via a branch 144, wherein the connection of the branch 144 is arranged via a node downstream of the switching unit 110. Further, a load unit 118 and a supply measuring unit 120 are arranged upstream of the switching unit 110 in the supply line 140.

The logic unit 110 can be connected to all components via further communication lines 146 to detect their status or relevant operating and/or performance data that are not relevant or subordinate to the safety function. These are not shown for reasons of clarity. The logic unit comprises additional, non-safety-relevant digital or analog inputs, outputs or other functional blocks not shown in the figures.

The switching unit 110 is connected to the supply input channel 106, the load unit 118, and the supply measuring unit 120 via communication lines 146, wherein, here, the load unit 118 is a resistor or a resistor group and the supply measuring unit 120 is a shunt resistance sensor.

The logic unit 104 is connected to the communication input channel 108 via communication lines 146 and, in addition to the connection to the coupler 102, to the communication output channel 154.

If the switching unit 110 detects an active supply input channel 106, the switching unit 110 switches depending on the defined switching period of, on hand, 500 ms for one pulse (pulse duration) of 25 ms and thus separates the logic unit 104 and the supply input channel 106 from the supply line 140.

For the duration of the pulse, the logic unit 104 continues to also detect the partial state and, if applicable, the identity of the communication input channel 108 and is supplied with voltage by the supply unit 112 to forward this information about the (possible) identity of the secure input. The voltage coming from the supply storage 114, a capacitor group, is reduced to a defined value by means of the power adapter 116, wherein the capacitors are recharged after the pulse from the supply line 140.

This power reduction is detectable in the PSE 200 since the power is switched on for the duration of the pulse. This represents an additional security feature.

In the deactivated safety state, a first safety channel (supply safety channel) 180 is formed, comprising the switching unit 110, the optional load unit 118 and the optional supply measuring unit 120 as well as the switchable supply input channel 106.

Completely independent of this, a second security channel is formed as a communication security channel 190 which includes an independent supply unit 112 for the logic unit 104 and the communication input channel 108 with the associated communication lines 146 as well as the optional communication output channel 154 with the associated communication line 146 to the logic unit 104.

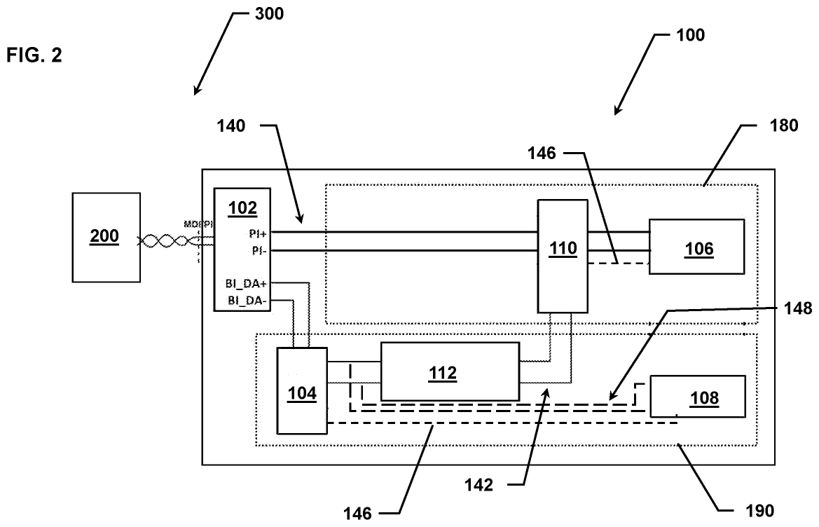

FIG. 2 shows an alternative exemplary embodiment, wherein overall all reference numbers have the identical meaning so they are not referenced and explained again. In this embodiment, the PD 100 comprises a coupler 102 and a switching unit 110 directly connected via the supply line 140, the switching unit 110 in turn being connected to the supply input channel 106. The logic unit 104 is connected to the supply line 140 via the switching unit 110 in the same way as in FIG. 1. In the exemplary embodiment shown, the communication input channel 108 is connected to the supply branch 142 via a node and a branch 148 for signal amplification downstream of the supply unit 112. In this case, the supply unit 112 and in particular the supply storage 114 are configured in such a way as to enable signal amplification. In an exemplary embodiment not shown, an analog branch 148 to the supply input channel 106 is also or alternatively provided. Analogous to FIG. 1, the PD 100 can in particular have an output channel 150 or further input channels.

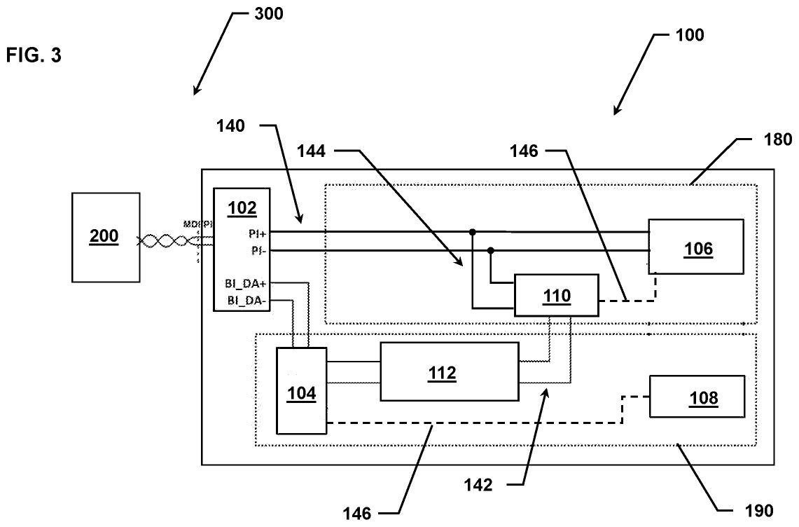

In the exemplary embodiment as shown in FIG. 3, the switching element 110 is not integrated into the supply line 140 but into the branch 144 downstream of a node.

The supply input channel 106 is therefore not affected by the deactivation of the switching element 110, and only the supply branch 142 for supplying the logic unit 104 can be deactivated.

This one is continuously supplied in an analogous manner by the supply unit 112 during a zero pulse. The unsafe state or safety state of the two input channels 106, 108 is transmitted redundantly to the PSE 200 via the respective security channels 180, 190, in the same way as in the exemplary embodiment according to FIG. 1. The supply security channel 180 is formed by the supply input channel 106 which can only be deactivated controlled by the PSE 200 as well the partial state detected there. The communication security channel 190 is formed by the communication input channel 108, the supply unit 112, and the logic unit 104 as well as the state recorded there via a protocol of the logic unit 104.

In an exemplary embodiment not shown, in the supply line 140 a supply measuring unit 120 may be provided in order to increase safety in the supply channel 180, the supply measuring unit 120 being connected to the logic unit 104 via a communication line, in particular via a galvanically isolated communication line. The detected state of the supply line 140 can therefore supplementary be transmitted to the PSE 200 via the logic unit 104 and the coupler 102.

Analogous to FIG. 1, the PD 100 can in particular have an output channel 150 or further input channels.

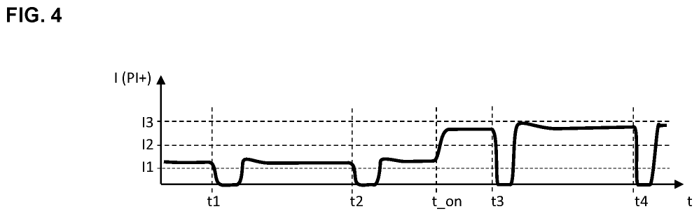

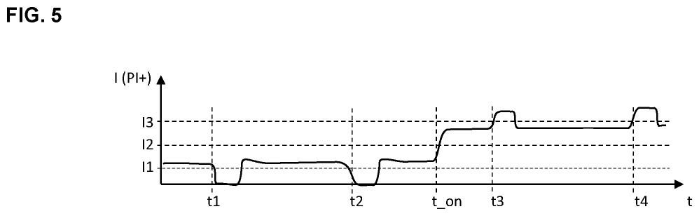

In FIGS. 4 and 5, the power consumption (y-axis) is plotted over the time (x-axis) in one respective graph, as it is present in the supply line 140, which is detectable by the PSE 200.

FIG. 4 shows how the power supply in the supply line 140 is deactivated for a defined pulse duration in the event of a pulse (zero pulse) by the switching unit 110 at the times t1 to t4, respectively. The safe input and the safe output in the supply safety channel 180 are not supplied with voltage during the pulse. This pulse can be used to distinguish the communication input channel 108 from the secure supply input channel 106 in the event of a cross-circuit between the two input channels 106, 108. The pulse through the switching unit 110 can also serve to cyclically test the safe output for its switch-off/deactivation capability by deactivation.

In the exemplary embodiment of the method according to FIG. 5, an adjustable load unit 118 and a supply measuring unit 120, in the form of a current measuring unit, are provided. In case of high power consumption, such as of the times t3 and t4, the power is not limited and the output to the PSE is open. In this case, it may be advantageous if the supply line 140 is not disconnected by the switching unit 110 and, instead of the pulse (zero pulse), a load pulse is generated which is also treated/regarded as a defined current value for the safety state of the input.

This exemplary embodiment of the method has the advantage and the effect that the safe input and the safe output in the supply safety channel are continuously supplied with voltage during the load pulse.

With the present disclosure, it has therefore become possible at a PD, such as a sensor-actuator unit or an input-output combination, to transmit the safety state (safety notice) in the direction from the PSE to the PD and from the PD to the PSE, even if the power has already been safely limited by the PSE. This is achieved by allowing to continuously operate the logic unit during the transmission of the safety state (safety notice) while the PD has at least one internal supply storage as a buffer element that is required to bridge the pulse (zero pulse).

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term comprising (and its grammatical variations) as used herein is used in the inclusive sense of having or including and not in the exclusive sense of consisting only of. The terms a and the as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### List of Reference Numerals

100 PD (powered device)
102 coupler
104 logic unit
106 supply input channel
108 communication input channel
110 switching unit
112 supply unit
114 supply storage
116 power adapter
118 load unit
120 supply measuring unit
128 PSE port
130 PSE port
132 power port (PD)
134 power port (PD)
136 communication port (PD)
138 communication port (PD)
140 supply line
142 supply branch
144 branch
146 communication line
148 branch
150 output channel
152 supply output channel
154 communication output channel
180 supply security channel (first security channel)
190 communication security channel (second security channel)
200 PSE (power source equipment)
300 network (SPE)
302 network line

1. A powered device for connection to a power sourcing equipment (PSE) via a network line of a network, the powered device comprising as electronic components:
a coupler configured to connect the powered device to the PSE and for separating supply and communication received via the network line;
at least one logic unit; and
at least two input channels, wherein the coupler has two PSE ports and at least four powered device ports (PD ports), of which at least two PD ports are power ports and at least two PD ports are communication ports, and wherein the electronic components are supplied directly or indirectly via the two power ports and a supply line,
wherein a switching unit is arranged in the supply line from the coupler to the at least one input channel and a supply branch extends from the switching unit to the logic unit, and wherein the logic unit contains a supply storage and/or is connected to the supply storage.

2. The powered device according to claim 1, wherein the switching unit is configured to cause one or more pulses and/or a characteristic pulse pattern for at least a period of time, detectable by at least the logic unit and/or the supplying PSE.

3. The powered device according to claim 1, wherein in the supply branch a supply unit is arranged which contains the supply storage and/or at least one further supply storage and a power adapter.

4. The powered device according to claim 1, wherein the supply storage comprises at least one passive storage component and at least one passive directional component.

5. The powered device according to claim 1, wherein the supply storage is configured and dimensioned in such a way that a level (size) and/or duration of the supply that can be provided does not enable operation of an output.

6. The powered device according to claim 1, wherein a load unit is provided in the supply line between the coupler and the switching unit.

7. The powered device according to claim 1, wherein in the supply line a supply measuring unit is provided which communicates with the switching unit and/or the logic unit, and wherein the switching unit is configured to generate a pulse depending on the supply value detected by the supply measuring unit.

8. A method for operating a powered device connected to a power sourcing equipment (PSE) in a network, wherein the powered device includes:
a coupler configured to connected the powered device to the PSE;
a supply line configured to supply electronic components;
a logic unit via which the powered device communicates with the PSE; and
at least two input channels; the method comprising:
transmitting at least two partial safety states from the powered device to the PSE;
achieving a safety state via at least two security channels, each security channel having a respective partial safety state, by:
transmitting, by a first input channel of the at least two input channels, a value of the supply in the supply line of the powered device to the PSE as the first partial state during a zero pulse or a load pulse in the supply line; and, in parallel,
transmitting, by a second input channel of the at least two input channels, an identity of data to the coupler via the logic unit as the second partial state; and
i) parallel to the zero pulse, separating the at least the logic unit from the supply line, and supplying the logic unit via a supply storage of the PD for a duration of the separation; or
ii) parallel to the load pulse, converting the voltage from a first higher voltage to a second lower voltage upstream of the logic unit.

9. The method according to claim 8, wherein the zero pulse and/or the load pulse is triggered and/or controlled by at least one switching unit.

10. The method according to claim 8, wherein the supply storage is charged via the supply line and is separated from the supply line by the switching unit, and wherein the supply storage is optionally separated from the supply line for the duration of a zero pulse

11. The method according to claim 8, wherein in the second partial state of the communication security channel in parallel to the zero pulse according to alternative i), the voltage provided by the supply storage is converted from a first higher voltage to a second lower voltage upstream of the logic unit.

12. The method according to claim 8, wherein in the first partial state of the supply safety channel at least one of the following circuits is present in parallel to the load pulse:
the first input channel is connected to the PSE and supply line in a current-conducting manner, and/or
an output channel is connected to the PSE and supply line in the current-conducting manner.

13. The method according to claim 8, wherein the presence of a safety state is generated by the switching unit clocked as a pulse, optionally with a pulse duration of 1 ms to 50 ms and a period duration of 300 ms to 800 ms.

14. The method according to claim 8, wherein the logic unit is supplied by the switching unit via the supply storage only for the duration of the separation from the supply line.

15. The method according to claim 8, wherein the supply provided by the supply storage does not enable operation of the output after the required level (size) and/or duration.

16. The method according to claim 8, wherein the powered device is configured to connect to the PSE via the network line of the network according to claim 1.

17. The powered device according to claim 4, wherein the storage component is a capacitance and/or an inductor and the at least one directional component is a diode.

18. The powered device according to claim 6, wherein the load unit is configured to communicate with the switching unit.

19. The method according to claim 8, wherein the value of the supply in the supply line is a current value or a current flow.

20. The method according to claim 9, wherein the at least one switching unit is arranged in the supply line.
